(19) United States
(12) Patent Application Publication
(10) Pub. No.: US 2016/0090953 A1
(43) Pub. Date: Mar. 31, 2016

(54) INJECTOR ASSEMBLY

(71) Applicant: HONDA MOTOR CO., LTD., Tokyo (JP)

(72) Inventor: Yusaburo TANI, Wako-shi (JP)

(21) Appl. No.: 14/844,171

(22) Filed: Sep. 3, 2015

(30) Foreign Application Priority Data
Sep. 30, 2014 (JP) 2014-200914

(51) Int. Cl. F02M 55/00; F02M 51/00; F02M 61/14

(52) U.S. Cl. CPC F02M 55/004; F02M 61/14; F02M 51/005

(57) ABSTRACT

A distal end portion of an injector is fitted into a mounting member. A fuel joint having a connecting pipe portion is connected to a proximal portion of the injector. A joint pressing member which restricts the displacement of the fuel joint in the direction away from the mounting member is fixed by fastening to the mounting member. The injector is fixed to the mounting member by restricting the displacement of the fuel joint by the joint pressing member.

### BACKGROUND

1. Field

The present invention relates to an injector which injects fuel to be supplied to an engine, and an injector assembly having a fuel joint for connecting a fuel hose to the injector.

2. Description of the Related Art

As an engine used for a vehicle such as a motorcycle, there has been known an engine where fuel is injected into the engine by an injector supported on a throttle body, an intake pipe, a cylinder head or the like.

In an injector used for this type of engine, a distal end portion of the injector is fitted into a mounting member of a throttle body or the like, and a fuel joint for taking in fuel is liquid-tightly connected to a proximal portion side of the injector. The fuel joint includes a fitting connecting portion which is fitted on the proximal portion side of the injector, and a connecting pipe portion for connecting a fuel hose to the fuel joint.

As an injector assembly having the above-mentioned injector and the fuel joint, there has been known an injector assembly where a fuel joint is fastened to a mounting member using bolts in such a manner that an injector is sandwiched between the fuel joint and the mounting member (for example, see Japanese Patent Publication JP-A-2004-183538 (Patent Literature 1)).

In the injector assembly disclosed in Patent Literature 1, a boss portion for fastening the injector assembly to the mounting member using bolts is integrally formed on the fuel joint besides a fitting connecting portion fitted into a proximal portion side of the injector and a connecting pipe portion for connecting a fuel hose to the fuel joint. The injector assembly is configured such that a distal end portion of the injector is fitted into a fitting hole formed in the mounting member in a state where the fuel joint is assembled to the proximal portion side of the injector in advance, and the boss portion of the fuel joint in such a state is fastened to the mounting member using bolts.

However, in the above-mentioned conventional injector assembly, the connecting pipe portion and the boss portion are integrally formed with the fuel joint and hence, the position of the boss portion fastened to the mounting member and the projecting direction of the connecting pipe portion to which the fuel hose is connected are decided univocally. Accordingly, in adopting the above-mentioned conventional injector assembly, a drawing angle of the fuel hose from the mounting member is univocally decided and hence, it is difficult to use such an injector assembly in common by vehicles having different specifications.

### SUMMARY

In view of the above, it is an object of the invention to provide an injector assembly which can be easily used in common by vehicles having different specifications.

To achieve the above-mentioned object, an injector assembly according to embodiments of the invention include an injector which has a distal end portion thereof fitted into a mounting member and injects fuel to be supplied to an engine. A fuel joint has a connecting pipe portion to which a fuel hose is connected, and is liquid-tightly connected to a proximal portion of the injector. The injector is fixed to the mounting member in a state where the injector is sandwiched between the fuel joint and the mounting member. The injector assembly further comprises a joint pressing member which is fixed by fastening to the mounting member and restricts the displacement of the fuel joint in the direction away from the mounting member.

Due to such a constitution, the displacement of the fuel joint in the direction away from the mounting member is restricted by the joint pressing member which is a part separate from the fuel joint. A projecting direction of the connecting pipe portion of the fuel joint is changeable by changing a relative angle of the fuel joint with respect to the joint pressing member.

The fuel joint can include a joint-side engagement flange which is disposed closer to the injector than the connecting pipe portion. The displacement of the joint-side engagement flange in the direction away from the injector is restricted by the joint pressing member.

In this case, the displacement of the fuel joint in the direction away from the injector is restricted by the joint pressing member at the joint-side engagement flange portion closer to the injector than the connecting pipe portion. Accordingly, the fuel joint does not largely project in the direction away from the injector compared to the connecting pipe portion and hence, the fuel joint can be miniaturized. Further, the joint pressing member can be also miniaturized.

An assembling angle positioning mechanism, capable of performing positioning of the fuel joint and the joint pressing member by selectively changing an assembling angle between the fuel joint and the joint pressing member may be provided between the fuel joint and the joint pressing member. The assembling angle positioning mechanism can include one fitting element and another fitting element which are engageable with each other by male-female fitting engagement. The one fitting element may be constituted of a plurality of fitting elements formed on the fuel joint with angles thereof changed in the circumferential direction. The other fitting element may be constituted of at least one fitting element formed on the joint pressing member. In this case, a relative angle of the joint pressing member with respect to the fuel joint can be easily changed by changing the combination of fitting engagement between one fitting element and the other fitting element of the assembling angle positioning mechanism.

The fuel joint can include a joint-side engagement flange whose displacement in the direction away from the injector is restricted by the joint pressing member. The injector can include an injector-side engagement flange whose displacement in the direction away from the fuel joint is restricted by the joint pressing member. The joint pressing member can include a clamping portion which, in a state where the fuel joint is connected to the proximal portion of the injector, is inserted into both the fuel joint and the injector from sides of the fuel joint and the injector and clamps the joint-side engagement flange and the injector-side engagement flange. In this case, when the clamping portion of the joint pressing member is inserted into the connecting portion between the fuel joint and the injector from the sides of the fuel joint and the injector, the joint-side engagement flange and the injector-side engagement flange are clamped by the clamping portion of the joint pressing member. As a result, a connection state between the fuel joint and the injector is maintained.

The clamping portion can be arranged at left and right sides so as to sandwich the fuel joint and the proximal portion of the injector. In this case, the clamping portion of the joint pressing member clamps the joint-side engagement flange and the injector-side engagement flange on both left and right sides of the fuel joint and the proximal portion of the injector. As a result, a connection state of the fuel joint and the injector can be stably maintained.

A connector which is an electric connection portion of a fuel injection portion can be formed on a side of the injector. The clamping portion of the joint pressing member may be inserted into the fuel joint and the injector from the direction opposite to a side where the connector is arranged. In this case, the clamping portion of the joint pressing member is assembled to the fuel joint and the injector without interfering with the connector.

According to certain embodiments of the invention, the joint pressing member which is a part separate from the fuel joint is provided, the joint pressing member is fixed by fastening to the mounting member, and the removal of the fuel joint from the mounting member is restricted by the joint pressing member. Accordingly, when vehicles differ from each other in a drawing angle of the fuel hose from the mounting member, the same injector assembly can be easily used in common by those vehicles by changing an angle of assembling the joint pressing member to the fuel joint.

### BRIEF DESCRIPTION OF THE DRAWINGS

FIG. 1 is a perspective view showing a mounting portion of an injector assembly according to certain embodiments of the invention.

FIG. 2 is a view of the mounting portion of the injector assembly according to certain embodiments of the invention as viewed in an axial direction of a connecting pipe portion.

FIG. 3 is a perspective view of an injector according to certain embodiments of the invention.

FIG. 4 is a perspective view of a fuel joint according to certain embodiments of the invention.

FIG. 5 is a plan view of the fuel joint according to certain embodiments of the invention.

FIG. 6 is a perspective view of a joint pressing member according to certain embodiments of the invention.

FIG. 7 is a view of the joint pressing member according to certain embodiments of the invention as viewed in the direction indicated by an arrow VII in FIG. 2.

FIG. 8 is a plan view of the injector assembly according to certain embodiments of the invention.

FIG. 9 is a view of the injector assembly according to certain embodiments of the invention as viewed in the direction indicated by an arrow IX in FIG. 8.

FIG. 10 is a cross-sectional view of the injector assembly according to certain embodiments of the invention taken along a line X-X in FIG. 9.

FIG. 11 is a cross-sectional view of the injector assembly according to certain embodiments of the invention taken along a line XI-XI in FIG. 8.

FIG. 12 is a cross-sectional view of the injector assembly according to certain embodiments of the invention taken along a line XII-XII in FIG. 9.

FIG. 13 is a cross-sectional view of the injector assembly according to certain embodiments of the invention taken along a line XIII-XIII in FIG. 9.

FIG. 14 is a cross-sectional view of an injector assembly according to other embodiments of the invention corresponding to FIG. 10.

### DETAILED DESCRIPTION

Hereinafter, certain embodiments of the invention are explained by reference to drawings. An injector assembly 1 is mounted on an intake system of an engine of a saddle-ride-type vehicle such as a motorcycle.

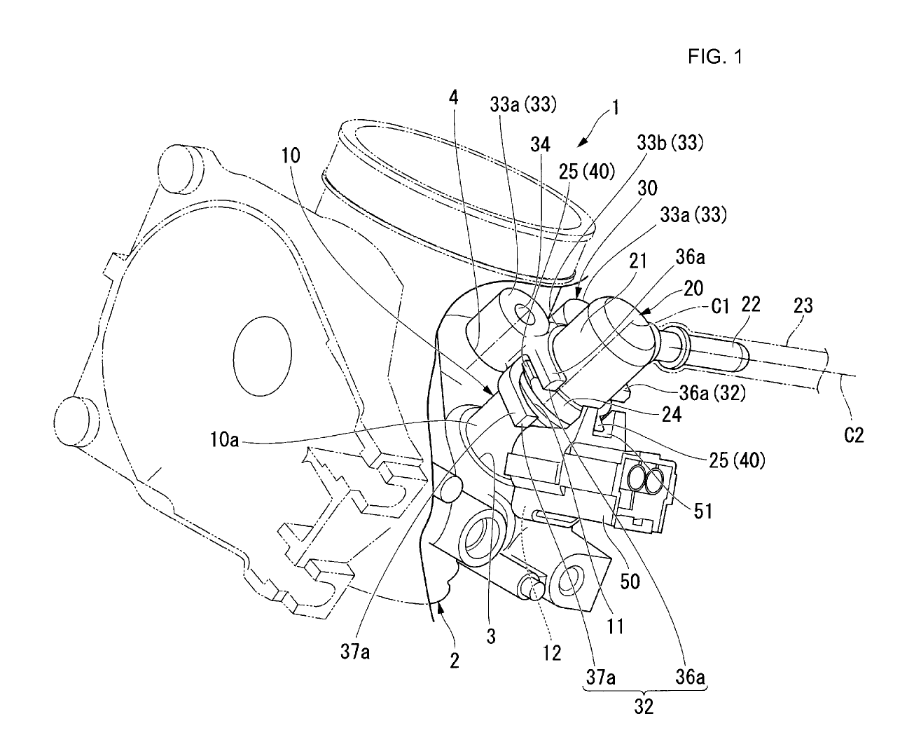

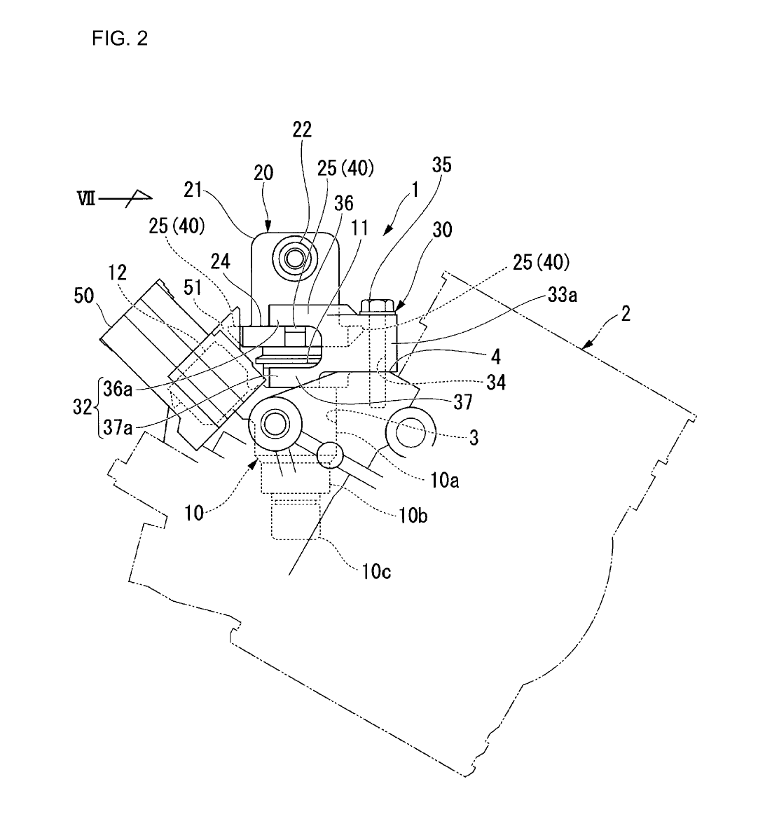

FIG. 1 and FIG. 2 are views showing a state where the injector assembly 1 is mounted on a throttle body 2 which is one form of a mounting member. The mounting member on which the injector assembly 1 is mounted is not limited to the throttle body 2 and may be other members in an intake system such as an intake pipe, a cylinder head of an engine or an air cleaner case.

The injector assembly 1 includes an injector 10 which has a distal end portion having a fuel injection portion (a fitting cylindrical portion 10b and a nozzle portion 10c described later) fitted into the throttle body 2 and injects fuel to be supplied to an engine into the inside of the throttle body 2. A fuel joint 20 is liquid-tightly fitted on and connected to a proximal portion (a connecting cylindrical portion 10d described later) of the injector 10. A joint pressing member 30 restricts the displacement of the fuel joint 20 in the direction away from the throttle body 2.

A fitting hole 3 into which a distal end portion of the injector 10 is fitted is formed in the throttle body 2. The distal end portion (nozzle portion 10c) of the injector 10 inserted into the fitting hole 3 faces the inside of an intake air passage not shown in the drawing which is formed in the inside of the throttle body 2. A mounting seat 4 to which the joint pressing member 30 is fixed by fastening is formed on an outer surface of the throttle body 2 at a position close to the fitting hole 3.

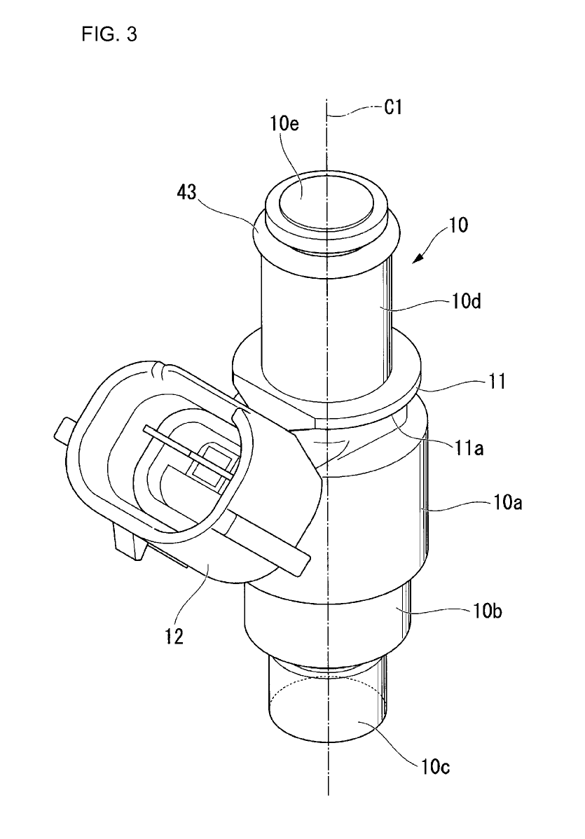

FIG. 3 is a view showing the injector 10.

The injector 10 receives a control signal from a controller not shown in the drawing so that a fuel injection time and fuel injection timing are controlled. The injector 10 is configured such that a small-diameter fitting cylindrical portion 10b which is fitted into the fitting hole 3 is contiguously formed with one end side (a distal end side described on a lower side in FIG. 3) of a large-diameter portion 10a in which a solenoid for injection control not shown in the drawing is housed, and the nozzle portion 10c having a smaller diameter than the fitting cylindrical portion 10b is contiguously formed with a distal end portion of the fitting cylindrical portion 10b.

The small-diameter connecting cylindrical portion 10d which is connected to the fuel joint 20 is contiguously formed with the other end side (a proximal end side described on an upper side in FIG. 3) of the large diameter portion 10a of the injector 10. An injector-side engagement flange 11 which projects outwardly in the radial direction is integrally formed on the connecting cylindrical portion 10d at a position away from the large diameter portion 10a by a predetermined distance. A tapered surface 11a which is tapered toward a large diameter portion 10a side is formed on the injector-side engagement flange 11 on a side facing the large diameter portion 10a. An extending end of the connecting cylindrical portion 10d forms a fuel introducing portion 10e through which fuel is introduced into the injector 10 from a fuel joint 20 side.

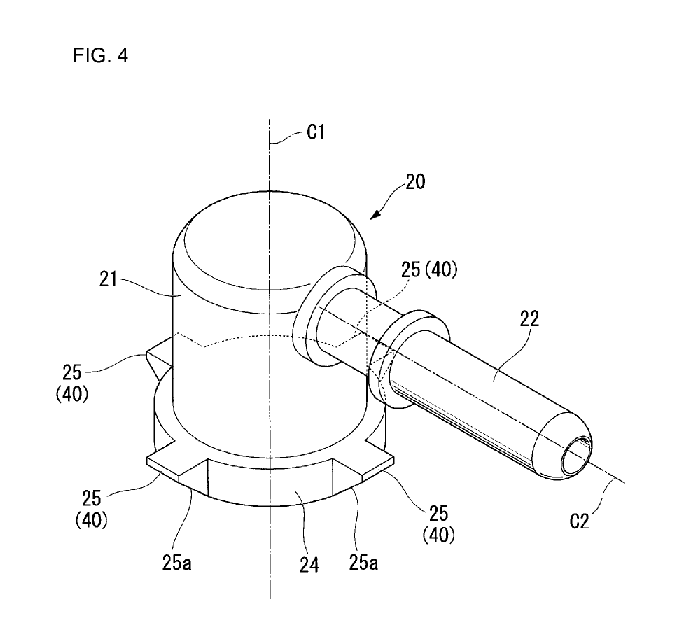

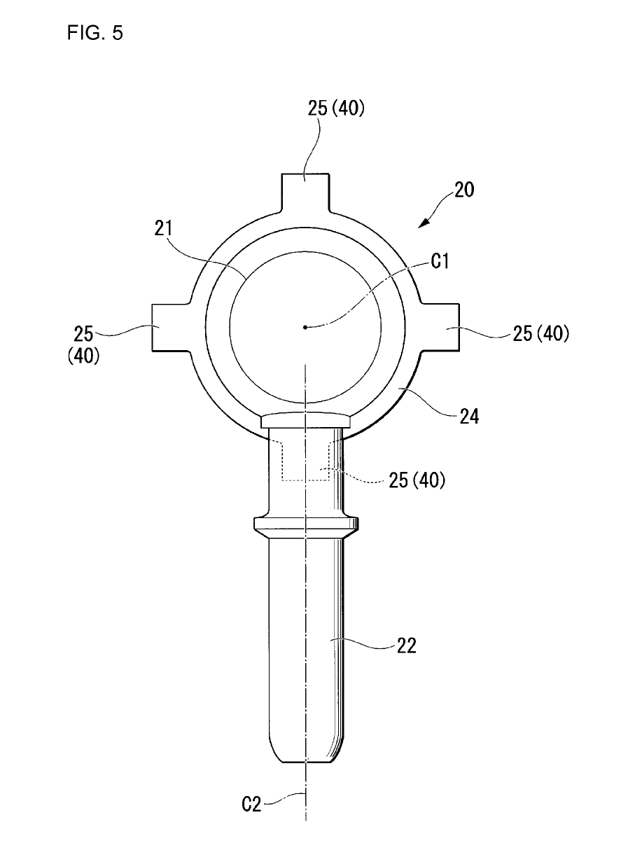

Further, a connector 12 which is an electric connecting portion for supplying electricity to the solenoid for an injection control is formed in a projecting manner on an outer surface of the large diameter portion 10a of the injector 10 at a position close to the other end of the large diameter portion 10a. FIG. 4 and FIG. 5 are views showing the fuel joint 20.

The fuel joint 20 includes a bottomed cylindrical joint body portion 21, and the fitting cylindrical portion 10b of the injector 10 on a proximal portion side is fitted into and connected to joint body portion 21. A connecting pipe portion 22 is formed in a projecting manner on an outer surface of the joint body portion 21 at a position close to a bottom portion of the joint body portion 21. As shown in FIG. 1, a fuel hose 23 is connected to the connecting pipe portion 22. Fuel pressurized to a high pressure is introduced into the fuel hose 23 by operating a fuel pump not shown in the drawing. The fuel hose 23 connected to the connecting pipe portion is fixed to the connecting pipe portion 22 by a fastening band or a connector not shown in the drawing.

In the drawing, symbol C1 indicates an axis of the injector 10 and the joint body portion 21 of the fuel joint 20, and symbol C2 indicates an axis of the connecting pipe portion 22 of the fuel joint 20.

A joint-side engagement flange 24 which projects outwardly in the radial direction is integrally formed on an edge of a peripheral wall of the joint body portion 21 on a side opposite to a bottom portion of the peripheral wall. Four projections 25 are formed on an outer peripheral surface of the joint-side engagement flange 24 at intervals of 90° along the circumferential direction. The projection 25 is formed into an approximately square shape as viewed in the axial direction of the joint body portion 21. Further, a tapered surface 25a is formed on the projection 25 such that the projection 25 is tapered toward an end portion of the peripheral wall of the joint body portion 21 on an opening side.

Any one of four projections 25 of the fuel joint 20 is fitted into a fitting hole 31 formed in the joint pressing member 30 described in detail later. The projections 25 and the fitting hole 31 constitute an assembling angle positioning mechanism 40 of this embodiment. In this example, four projections 25 of the fuel joint 20 constitute one fitting element which is engageable by male-female fitting engagement, and the fitting hole 31 formed in the joint pressing member 30 constitutes the other fitting element which is engageable by male-female fitting engagement.

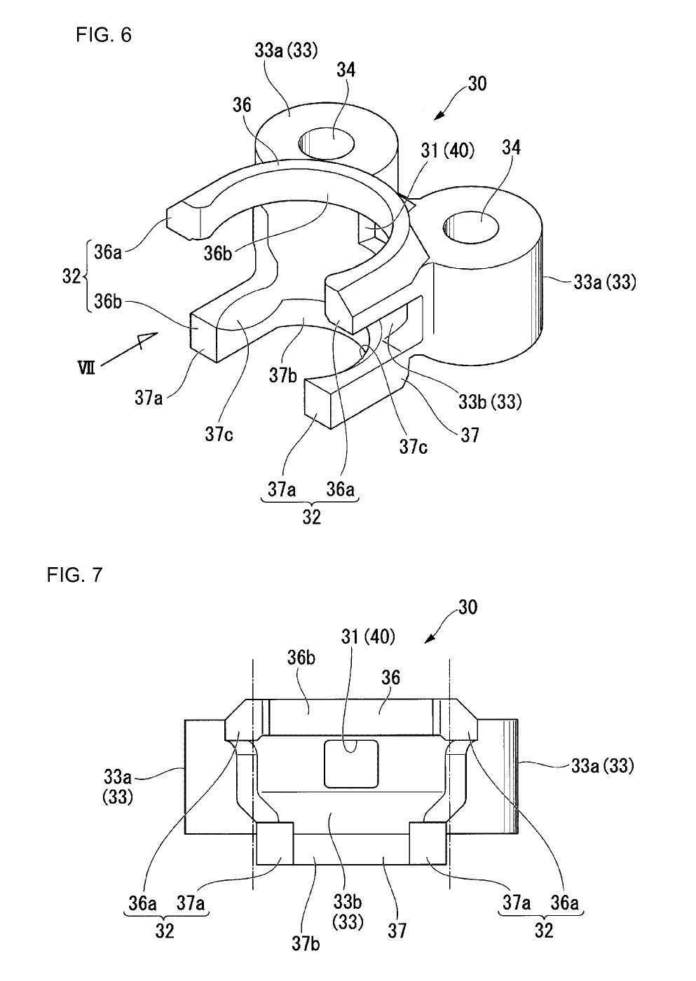

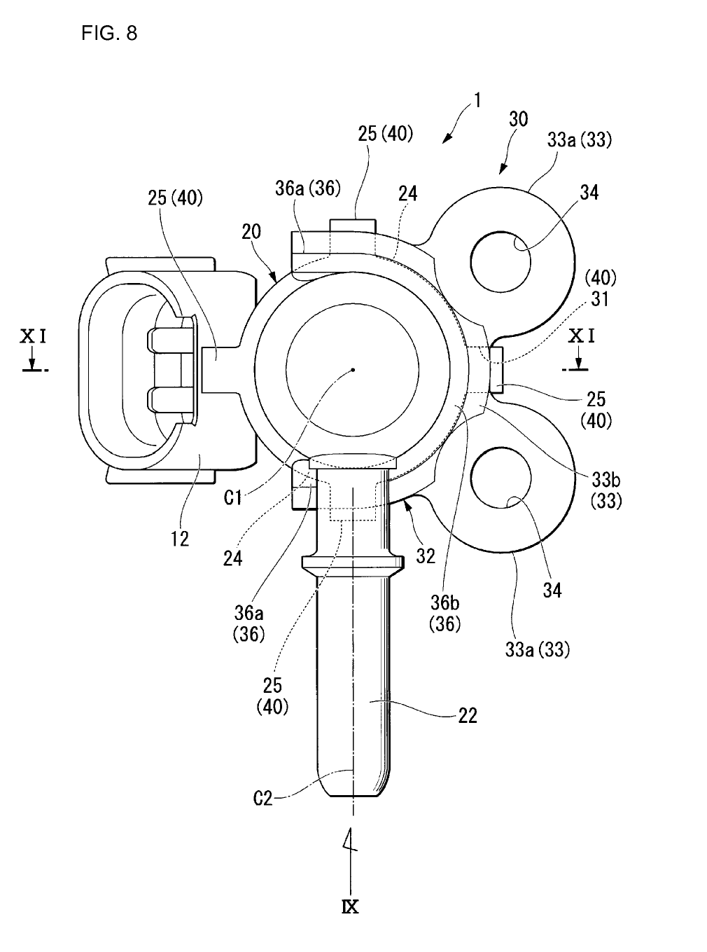

FIG. 6 and FIG. 7 are views showing the joint pressing member 30.

The joint pressing member 30 includes a mounting proximal portion 33 having a pair of boss portions 33a, 33a which is fastened to the mounting seat 4 of the throttle body 2 using bolts. A pair of left and right clamping portions 32, 32 are formed on the mounting proximal portion 33 in an extending manner and makes the fuel joint 20 and the injector 10 which are connected to each other by fitting engage with each other.

The mounting proximal portion 33 includes an arcuate wall 33b having an approximately arcuate shape which covers a portion of the outer periphery of a connecting portion between the fuel joint 20 and the injector 10 in the circumferential direction. The above-mentioned boss portions 33a, 33a are mounted in a projecting manner on an outer surface of the arcuate wall 33b at two positions spaced apart from each other in the arcuate direction. The previously-mentioned fitting hole having an approximately square shape as viewed in a front view is formed in an approximately center portion of the arcuate wall 33b in the arcuate direction. The boss portions 33a, 33a are formed into an approximately circular columnar shape, and a bolt insertion hole 34 is formed in a center portion of each boss portion 33a, 33a. As shown in FIG. 2, bolts 35 for fastening and fixing the joint pressing member 30 to the throttle body 2 are inserted into the bolt insertion holes 34.

A first support member 36 having an approximately U shape is contiguously formed with one end side of the arcuate wall 33b of the mounting proximal portion 33 in the axial direction, and a second support member 37 having an approximately U shape is contiguously formed on the other end side of the arcuate wall 33b in the axial direction. The first support member 36 includes a pair of arm portions 36a, 36a which extends substantially parallel to each other from a circular arcuate portion 36b on a mounting proximal portion 33 side, and the arm portions 36a, 36a are brought into contact with an end surface of the joint-side engagement flange 24 on a side away from the injector 10. In the same manner, the second support member 37 includes a pair of arm portions 37a, 37a which extends substantially parallel to each other from a circular arcuate portion 37b on a mounting proximal portion 33 side, and the arm portions 37a, 37a are brought into contact with an end surface (tapered surface 11a) of the injector-side engagement flange 11 on a side away from the fuel joint 20. On a contact surface of each arm portion 37a which is brought into contact with the injector-side engagement flange 11, a tapered surface 37c which is brought into surface contact with the tapered surface 11a of the injector-side engagement flange 11 is formed.

Cutout-like gaps which are spaced apart from each other in the axial direction of the fuel joint 20 are formed between the arm portion 36a of the first support member 36 and the arm portion 37a of the second support member 37. The left and right arm portions 36a, 37a which are vertically arranged in a spaced-apart manner respectively form pairs in the vertical direction thus forming the clamping portions 32 respectively.

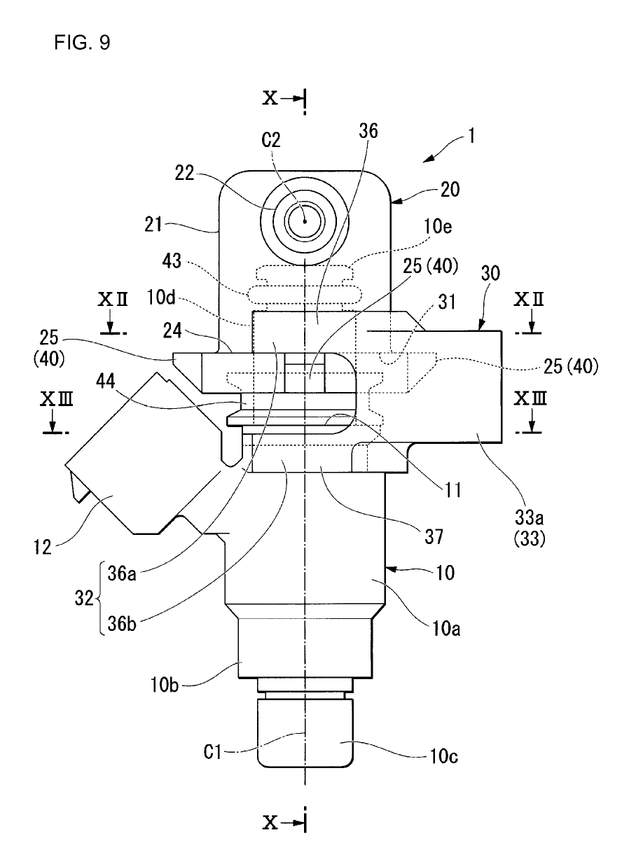

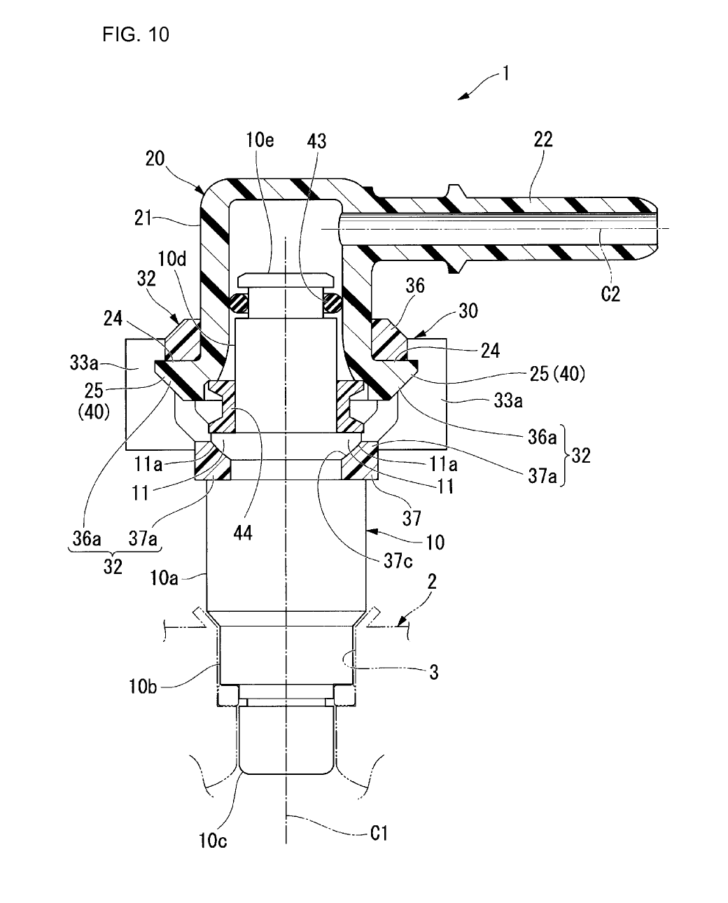

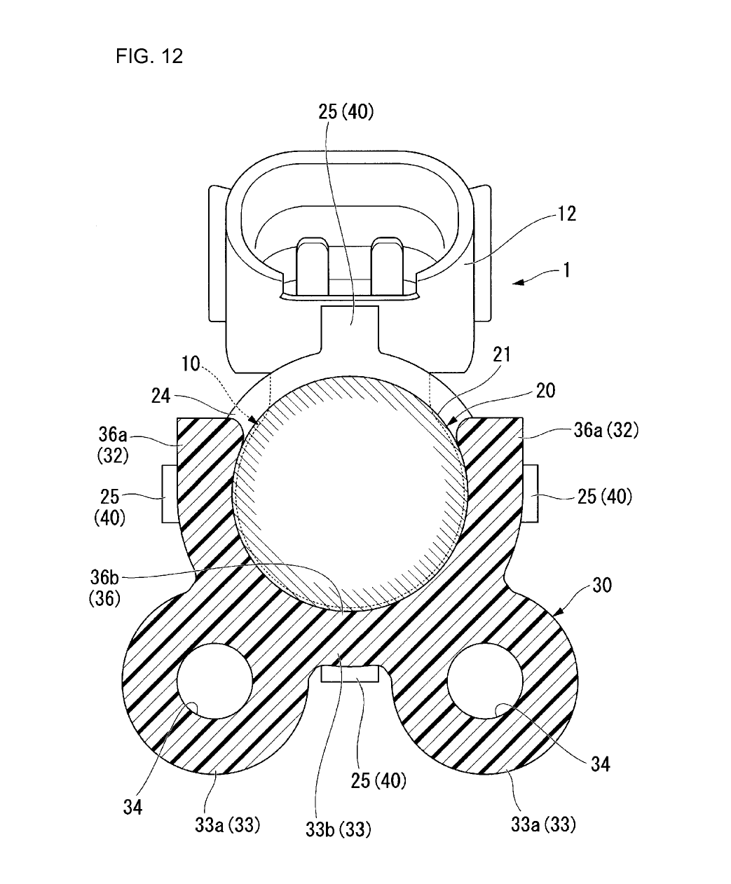

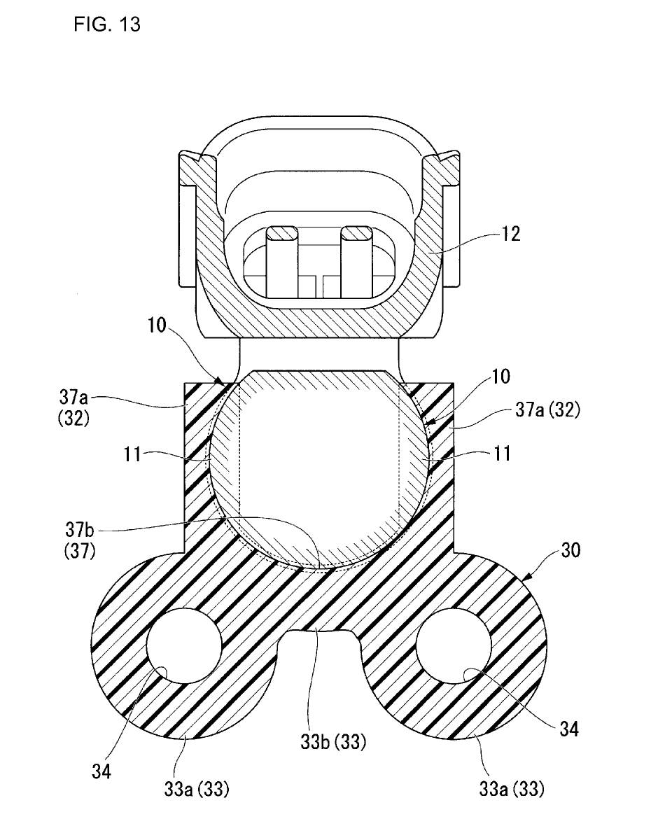

FIG. 8 to FIG. 13 are views showing the injector assembly 1 where the fuel joint 20 and the joint pressing member 30 are assembled to the injector 10. FIG. 8 is a plan view of the injector assembly 1, FIG. 9 is a side view of the injector assembly 1, and FIG. 10 to FIG. 13 are cross-sectional views of the injector assembly 1.

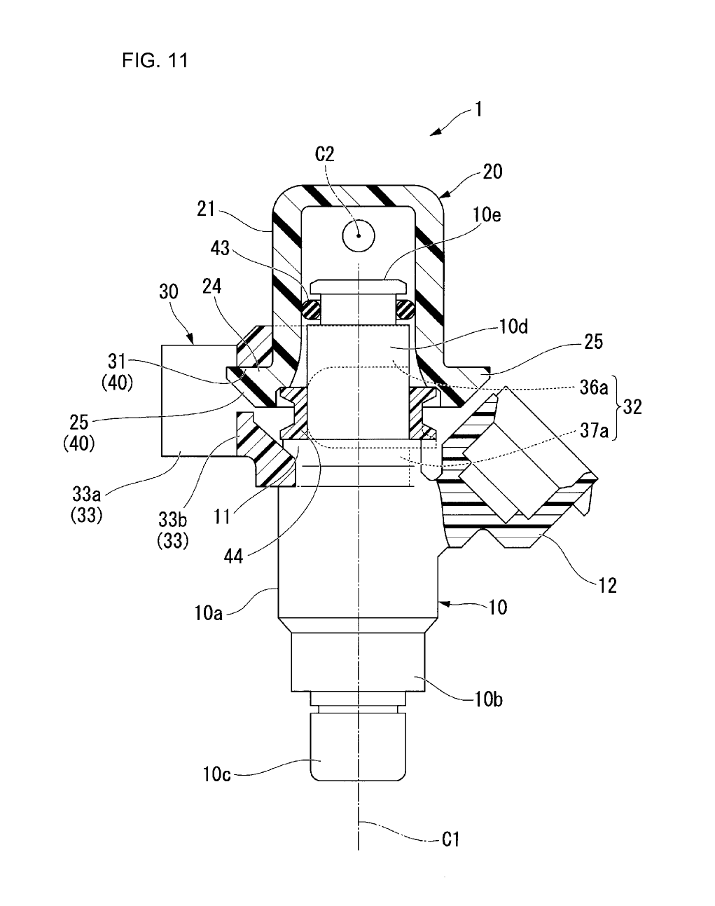

The joint body portion 21 of the fuel joint 20 is fitted on the connecting cylindrical portion 10d of the injector 10. As shown in FIG. 10 and FIG. 11, a ring-shaped seal member 43 is interposed between the connecting cylindrical portion 10d and the joint body portion 21 for liquid-tightly sealing a gap therebetween. In the drawings, symbol 44 indicates a cylindrical dust seal which is interposed between the connecting cylindrical portion 10d and the joint body portion 21 so as to prevent the intrusion of dust, mud and the like into a connecting portion between the connecting cylindrical portion 10d and the joint body portion 21.

A positioning portion not shown in the drawing is provided between the injector 10 and the fuel joint 20 for positioning a relative angle between the connecting cylindrical portion 10d and the joint body portion 21 in the circumferential direction. The fuel joint 20 and the injector 10 are assembled to each other such that the position of the fuel joint 20 at which the connecting pipe portion 22 projects and the connector 12 of the injector are displaced from each other by 90° in the circumferential direction.

The joint pressing member 30 is engaged with the connecting portion between the fuel joint 20 and the injector 10 which are fitted and connected to each other by the clamping portions 32. To be more specific, the left and right arm portions 36a, 36a of the first support member 36 of the joint pressing member 30 are engaged with the outer peripheral surface of the joint body portion 21 of the fuel joint 20, and the left and right arm portions 37a, 37a of the second support member 37 are engaged with the proximal-end-side outer peripheral surface of the connecting cylindrical portion 10d of the injector 10. At this stage of assembling operation, the left and right arm portions 36a, 36b of the first support member 36 are brought into contact with an end surface of the joint-side engagement flange 24 on a side away from the injector 10, and the left and right arm portions 37a, 37a of the second support member 37 are brought into contact with an end surface of the injector-side engagement flange 11 on a side away from the fuel joint 20. Accordingly, the fuel joint 20 and the injector 10 are clamped by the left and right clamping portions 32, 32 of the joint pressing member 30. The left and right arm portions 37a, 37a of the second support member 37 and the injector-side engagement flange 11 are brought into contact with each other by way of the tapered surfaces 37c, 11a.

When the left and right clamping portions 32, 32 of the joint pressing member 30 are engaged with the connecting portion between the fuel joint 20 and the injector 10 in this manner, the left and right clamping portions 32, 32 are inserted into the connecting portion between the fuel joint 20 and the injector 10 from the direction opposite to a side of the injector 10 where the connector 12 is arranged. At this stage of the assembling operation, the projections 25 which project in the leftward and rightward directions from the edge of the joint body portion 21 of the fuel joint 20 are inserted into cutout-like gaps each of which is formed between the arm portion 36a of the first support member 36 and the arm portion 37a of the second support member 37 which are spaced apart from each other in the axial direction.

When the left and right clamping portions 32, 32 are deeply inserted into the connecting portion between the fuel joint 20 and the injector 10, the projection 25 which projects from the edge of the joint body portion 21 toward a mounting portion 33 side of the joint pressing member 30 is inserted into the fitting hole 31 formed in the arcuate wall 33b of the mounting proximal portion 33. Due to such a constitution, a relative assembling angle between the joint pressing member 30 and the fuel joint 20 is positioned.

In the example shown in FIG. 1, FIG. 2 and FIG. 8 to FIG. 13, the projection 25 positioned on a left side of the connecting pipe portion 22 as viewed in a top plan view of the fuel joint 20 is inserted into the fitting hole 31. However, the projection 25 which is inserted into the fitting hole 31 is suitably changed corresponding to an assembling angle of the injector 10 and an assembling angle of the fuel joint 20 with respect to the throttle body 2, that is, corresponding to the drawing direction of the fuel hose 23 from the injector 10 for every vehicle to which the injector assembly 1 is applied.

In the injector assembly 1, in this state, the distal end portion (the fitting cylindrical portion 10b) of the injector 10 is liquid-tightly fitted into the fitting hole 3 formed in the throttle body 2, and the boss portions 33a, 33a of the joint pressing member 30 are fastened to the mounting seat 4 of the throttle body 2 by the bolts 35.

As shown in FIG. 1 and FIG. 2, a mating connector 50 which is connected to an electric cable (not shown in the drawing) is fitted and connected to the connector 12 of the injector 10 after the injector assembly 1 is mounted on the throttle body 2. A groove portion 51 having an approximately rectangular cross section is formed on an outer surface of the mating connector 50 along the axial direction. The groove portion 51 has a function that the projection 25 of the fuel joint 20 arranged on the same side where the connector 12 projects when the mating connector 50 is fitted and connected to the connector 12 restricts the position of the mating connector 50 in the rotational direction.

As has been explained previously, in the example the injector assembly 1, the joint pressing member 30 which is a part separate from the fuel joint 20 is provided, and the joint pressing member 30 is fastened to the throttle body 2 using the bolts and hence, the removable of the fuel joint 20 from the throttle body 2 can be restricted by the joint pressing member 30. Accordingly, when the injector assembly 1 is applied to vehicles which differ from each other in a drawing angle the fuel hose 23 from the throttle body 2, the same injector assembly 1 can be easily used in common by those vehicles by changing an assembling angle of the joint pressing member 30 to the fuel joint 20.

That is, when the injector assembly 1 is applied to vehicles which differ in a drawing angle of the fuel hose 23 from the throttle body 2, in assembling the injector assembly 1, an assembling angle of the joint pressing member 30 to the fuel joint 20 is changed such that the connecting pipe portion 22 is directed in the direction which substantially agrees with the drawing direction of the fuel hose 23 and, in such a state, the connecting portion between the fuel joint 20 and the injector 10 is clamped by the clamping portions 32, 32 of the joint pressing member 30. At this stage of the assembling operation, the corresponding projection 25 on a fuel joint 20 side is fitted into the fitting hole 31 formed in the joint pressing member 30. The injector assembly 1 can cope with different drawing angles of the fuel hose 23 by fastening the boss portions 33a, 33a to the throttle body 2 using bolts without any additional operation.

In the illustrated example of injector assembly 1, the joint-side engagement flange 24 is formed on the fuel joint 20 at a position closer to the injector 10 than the connecting pipe portion 22, and the joint-side engagement flange 24 is pressed in the direction toward the injector 10 by the clamping portions 32, 32 of the joint pressing member 30. Accordingly, the displacement of the fuel joint 20 and the injector 10 can be surely restricted while suppressing a projection amount of the fuel joint 20 in the direction away from the injector 10. Accordingly, in this example of injector assembly 1, the fuel joint 20 can be miniaturized and, at the same time, the joint pressing member 30 can be also miniaturized.

In this example, the plurality of projections 25 are formed on the joint body portion 21 of the fuel joint with angles thereof changed in the circumferential direction, the fitting hole 31 into which any one of the projections 25 formed on a fuel joint 20 side can be selectively fitted is formed in the joint pressing member 30, and the projections 25 and the fitting hole 31 constitute the assembling angle positioning mechanism 40 which can perform the positioning of the fuel joint 20 and the joint pressing member 30 by selectively changing an assembling angle of the fuel joint 20 and the joint pressing member 30. Accordingly, a relative angle of the joint pressing member 30 with respect to the fuel joint 20 can be easily changed by changing the combination of the fitting hole 31 and the projection 25 fitted into the fitting hole 31.

The four projections 25 are formed in this example on a fuel joint 20 side, and one fitting hole 31 into which any one of the projections 25 can be fitted is formed on a joint pressing member 30 side. However, the number of projections 25 formed on a fuel joint 20 side may be arbitrarily set provided that the number of projections 25 is two or more. The number of fitting holes 31 into which the projection 25 can be fitted is not limited to one and may be set arbitrarily.

Further, in certain embodiments, a plurality of projections 25 are formed on a fuel joint 20 side, and at least one fitting hole 31 is formed on a joint pressing member 30 side. To the contrary, a plurality of fitting holes may be formed on a fuel joint 20 side with angles thereof changed in the circumferential direction, and at least one projection which can be fitted into any one of the fitting holes may be formed on a joint pressing member 30 side.

Further, in certain embodiments of injector assembly 1, the joint-side engagement flange 24 is formed on the fuel joint 20, and the injector-side engagement flange 11 is formed on the injector 10, and the clamping portions 32, 32 which are inserted into the connecting portion between the fuel joint 20 and the injector 10 from the side of the connecting portion and clamp the joint-side engagement flange 24 and the injector-side engagement flange 11 are formed on the joint pressing member 30. Accordingly, by merely inserting the clamping portions 32, of the joint pressing member 30 into the connecting portion between the fuel joint 20 and the injector 10 from the side of the connecting portion, the fuel joint 20 and the injector 10 can be easily and surely maintained in a connection state.

Particularly, in certain embodiments of injector assembly 1, the pair of clamping portions 32, 32 are arranged on left and right sides with the connecting portion between the fuel joint 20 and the injector 10 interposed therebetween and hence, the connection state between the fuel joint 20 and the injector 10 can be stably maintained while keeping a balance in the lateral direction.

Further, the connector 12 can be formed on the side of the joint body portion 21 of the injector 10 in a projecting manner, the clamping portions 32 of the joint pressing member 30 are inserted into the connecting portion between the fuel joint 20 and the injector 10 from the direction opposite to a side where the connector 12 is arranged. Accordingly, the clamping portions 32, 32 of the joint pressing member 30 can be easily assembled to the connecting portion between the fuel joint 20 and the injector 10 without interfering with the connector 12.

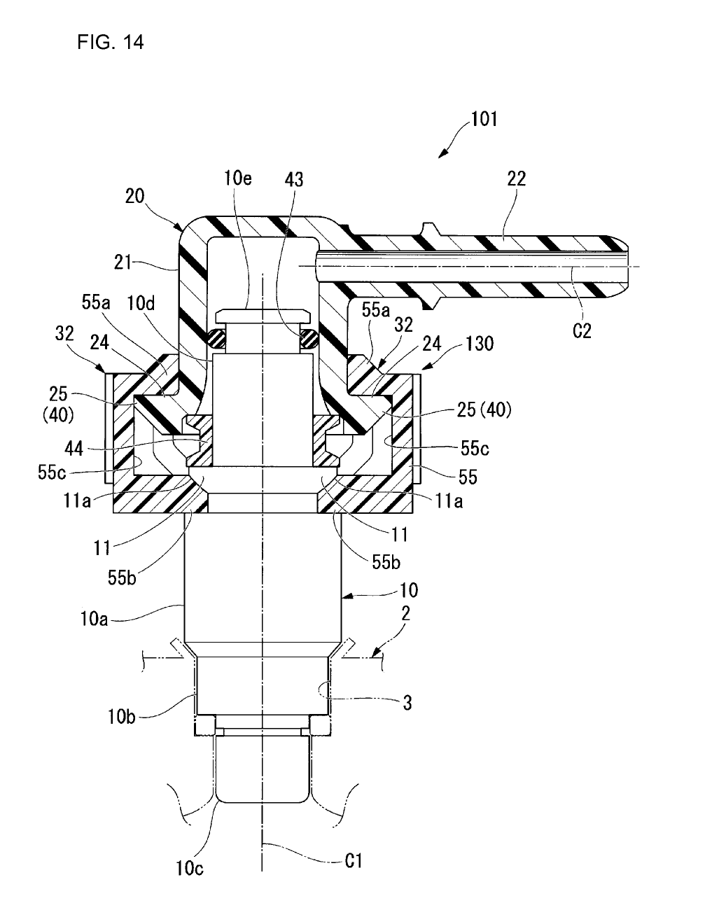

FIG. 14 is a view showing an injector assembly 101 according to another embodiment. In FIG. 14, parts identical with the parts of the above-mentioned embodiments are given the same symbols.

In the above-mentioned embodiments, the arm portion 36a of the first support member 36 and the arm portion 37a of the second support member 37 are formed individually and in a spaced-apart manner on the clamping portions 32, 32 which make the joint-side engagement flange 24 and the injector-side engagement flange 11 engage with each other. In another embodiment shown in FIG. 14, the joint-side engagement flange 24 and the injector-side engagement flange 11 are made to engage with each other using one support member 55 without instead of using two support members spaced apart from each other. A pair of arm portions 55a, 55a and a pair of arm portions 55b, 55b can be formed in an extending manner on one end side and the other end side of the support member 55 in the axial direction respectively, and a groove portion 55c for preventing the support member 55 from interfering with the projections 25 is formed between the arm portion 55a and the arm portion 55b spaced apart from each other in the axial direction.

The injector assembly 101 according to other embodiments can basically acquire substantially the same basic advantageous effects as the above-mentioned embodiments. However, in another embodiment, the sides of the connecting portion between the fuel joint 20 and the injector 10 are covered by the support member 55 and hence, another embodiment can acquire an additional advantageous effect that dust and mud minimally enter the connecting portion from the outside.

The invention is not limited to the above-mentioned embodiments, and various design changes are conceivable without departing from the gist of the invention.

### DESCRIPTION OF REFERENCE NUMERALS AND SIGNS

1, 101: injector assembly
2: throttle body (mounting member)
10: injector
11: injector-side engagement flange
12: connector
20: fuel joint
22: connecting pipe portion
23: fuel hose
24: joint-side engagement flange
25: projection (one fitting element)
30: joint pressing member
31: fitting hole (the other fitting element)
32: clamping portion
40: assembling angle positioning mechanism

1. An injector assembly, comprising:
an injector including a distal end portion thereof fitted into a mounting member, wherein the injector is configured to supply fuel to an engine;
a fuel joint including a connecting pipe portion to which a fuel hose is connected, and is liquid-tightly connected to a proximal portion of the injector, wherein the injector is fixed to the mounting member in a state where the injector is sandwiched between the fuel joint and the mounting member; and
a joint pressing member which is fixed by fastening to the mounting member and which is configured to restrict displacement of the fuel joint in a direction away from the mounting member.

2. The injector assembly according to claim 1, wherein the fuel joint includes a first joint-side engagement flange which is disposed closer to the injector than the connecting pipe portion, displacement of the first joint-side engagement flange in a direction away from the injector being restricted by the joint pressing member.

3. The injector assembly according to claim 1, further comprising an assembling angle positioning mechanism configured to selectively change an assembling angle between the fuel joint and the joint pressing member, said assembling angle positioning mechanism being disposed between the fuel joint and the joint pressing member,
wherein the assembling angle positioning mechanism includes a first fitting element and a second fitting element which are engageable with each other by male-female fitting engagement,
wherein the first fitting element comprises a plurality of fitting elements formed on the fuel joint with angles thereof changed in a circumferential direction, and
wherein the second fitting element comprises at least one fitting element disposed on the joint pressing member.

4. The injector assembly according to claim 2, wherein the fuel joint includes a second joint-side engagement flange whose displacement in the direction away from the injector is restricted by the joint pressing member,
the injector includes an injector-side engagement flange whose displacement in the direction away from the fuel joint is restricted by the joint pressing member, and
the joint pressing member includes a clamping portion which, in a state where the fuel joint is connected to a proximal portion of the injector, is inserted into both the fuel joint and the injector from sides of the fuel joint and the injector and clamps the second joint-side engagement flange and the injector-side engagement flange.

5. The injector assembly according to claim 4, wherein the clamping portion is disposed at left and right sides so as to sandwich the fuel joint and the proximal portion of the injector.

6. The injector assembly according to claim 4, further comprising a connector, which is an electric connection portion of a fuel injection portion, disposed on a side of the injector,
wherein the clamping portion of the joint pressing member is inserted into the fuel joint and the injector from a direction opposite to a side where the connector is disposed.

7. An injector assembly, comprising:
injector means for injecting fuel into an engine, said injector means including a distal end portion fitted into a mounting member;
fuel joint means for connecting a fuel hose to the injector means, said fuel joint means being liquid-tightly connected to a proximal portion of the injector means, wherein the injector means is fixed to the mounting member such that the injector means is sandwiched between the fuel joint means and the mounting member; and
joint pressing means for restricting displacement of the fuel joint means, said joint pressing means being fixed by fastening to the mounting member and for restricting the displacement of the fuel joint means in a direction away from the mounting member.

8. The injector assembly according to claim 7, wherein the fuel joint means includes first joint-side engagement means disposed closer to the injector means than the connecting pipe portion, displacement of the first joint-side engagement means in a direction away from the injector means being restricted by the joint pressing means.

9. The injector assembly according to claim 7, further comprising assembling angle positioning means for selectively changing an assembly angle between the fuel joint means and the joint pressing means, said assembly angle positioning means being disposed between the fuel joint means and the joint pressing means,
wherein the assembling angle positioning means includes a first fitting means and a second fitting means which are engageable with each other by a male-female fitting engagement,
wherein the first fitting means comprises a plurality of fitting elements formed on the fuel joint means with angles thereof changed in a circumferential direction, and
wherein the second fitting means comprises at least one fitting element disposed on the joint pressing means.

10. The injector assembly according to claim 8, wherein the fuel joint includes a second joint-side engagement means whose displacement in the direction away from the injector means is restricted by the joint pressing means,
wherein the injector means includes an injector-side engagement means whose displacement in the direction away from the fuel joint means is restricted by the joint pressing means, and
wherein the joint pressing means includes a clamping means which, in a state where the fuel joint means is connected to a proximal portion of the injector means, is inserted into both the fuel joint means and the injector means from sides of the fuel joint means and the injector means and clamps the second joint-side engagement means and the injector-side engagement means.

11. The injector assembly according to claim 10, wherein the clamping means is disposed at left and right sides so as to sandwich the fuel joint means and the proximal portion of the injector means.

12. The injector assembly according to claim 10, further comprising connector means disposed on a side of the injector means,
wherein the clamping means of the joint pressing means is inserted into the fuel joint means and the injector means from a direction opposite to a side where the connector means is disposed.

13. The injector assembly according to claim 12, wherein the connector means comprises an electric connection portion of a fuel injection portion.
